(19) United States
(12) Patent Application Publication
(10) Pub. No.: US 2007/0004434 A1
(43) Pub. Date: Jan. 4, 2007

(54) Method and system for ordering and carrying out printing and mailing services

(76) Inventors: Juergen Hofmann, Koeln (DE); Joachim Rick, Koenigswinter (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/559,489

(22) PCT Filed: Apr. 29, 2004
(86) PCT No.: PCT/DE04/00894

§ 371 Date: May 8, 2006

(30) Foreign Application Priority Data
May 28, 2003 (DE) 10324583.3

(51) Int. Cl. H04Q 7/20

(52) U.S. Cl. 455/466

(57) ABSTRACT

A method and system for ordering and performing printing services and mailing services are provided in which a user is location-independent and, in a way that involves little effort on his part, can generate an order for an individual piece of mail that is to be printed and sent, and the user has a great deal of freedom in selecting the design of the mail.

### BACKGROUND OF THE INVENTION

1. Field of the Invention

The invention relates to a method for the automated ordering and performing of printing services and mailing services in a mailing service system, with which the order data for mail to be printed and sent is generated by a mobile terminal, whereby the mobile terminal belongs to a mobile system.

The invention also relates to a system for carrying out a method for the automated ordering and performing of printing services and mailing services in a mailing service system, with which an order for mail to be printed and sent can be generated on a mobile terminal.

2. Description of Related Technology

In known systems for printing services in combination with mailing services (mailing service systems), so-called hybrid mail services are becoming more and more widespread. Providers of such services allow the users of an associated system to submit electronic data for postal products such as letters, postcards, mailings, etc., after which this data is edited and—optionally provided with other added-value services—converted into the physical final products. Afterwards, the addressed products are forwarded to a logistics process for purposes of distribution.

The addressed mail can be, for example, either classic types of letters or postcards or else electronic messages in the form of e-mails. Such mailings are used in large volumes especially for advertising and/or information campaigns. For example, comprehensive mailing campaigns are used to publicize new companies to certain segments of the population and to mail out information brochures or catalogs. More-over, for certain occasions such as special sales and events, information mailings are sent out in large volumes. Mailing campaigns of various types are also suitable for sending cards for holidays, for example, at Christmas time.

Typically, however, utilization of the service is associated with many restrictions and obstacles for users of a hybrid mailing system. For example, minimum batch sizes are required since otherwise the production is not cost-effective for the provider of the service. Moreover, invoicing for the individual services is not cost-effective for the service providers if they do not require certain minimum batch sizes. Furthermore, normally speaking, a special auxiliary means for the user is needed for generating the electronic data. This is often special software that has to be installed in the customer's environment in order to edit the customer data in such a way that it can be prepared for a printing order submitted to the provider. It is also a known procedure to use converters at the provider's facilities in order to be able to edit transmitted customer data so as to prepare it for production.

However, the generation of an order for printing and mailing an individual piece of mail whose design can be selected by the user is not possible with such systems.

Therefore, there is a need for a method and a system that allow a user to commission a mailing service provider, for example, with the personalized printing of an individual postcard and the subsequent sending of said postcard.

Another drawback of known systems is that the means for generating orders for mail that is to be printed and sent is often tied to a certain location because of the required auxiliary means. Consequently, there is also a need for a system that allows a user to generate location-independent orders for mail that is to be printed and sent.

U.S. Pat. No. 5,805,810 discloses, for example, a method for generating mail-pieces from e-mail messages. The method provides that an e-mail message is sent in a computer system comprising at least one database with an identification of the sender and of the appertaining recipient as well as a message checking unit. The database comprises address information of senders and recipients. When an electronic message is sent to the checking unit, it accesses the database entry pertaining to the sender in a sender database and determines the sender's address from this. Moreover, the unit checks whether the ascertained sender has sufficient credit in an account for sending a mailpiece. Then, on the basis of the recipient identification, the delivery address of the registered recipient is ascertained in the recipient database. A printing component generates a print-out from the text of the e-mail and provides this mailpiece with the sender and recipient addresses.

Moreover, U.S. Pat. Appln. No. 2002/0132609 A1 discloses a scalable system for transmitting messages that is configured as a wireless network. Wireless equipment such a PDAs, mobile telephones or laptops can send and receive messages.

### GENERAL DESCRIPTION OF THE INVENTION

Consequently, the invention provides a method for ordering and performing printing services and mailing services in a system in which a user is location-independent and, in a way that involves little effort on his part, can generate an order for an individual piece of mail that is to be printed and sent, whereby the user has a great deal of freedom in selecting the design of the mail.

The invention provides a system for carrying out a method for ordering and performing individual printing services and mailing services in which an order for mail that is to be individually printed and mailed can be generated by a user in a way that is location-independent and that involves little effort on his part, whereby the user has a great deal of freedom in selecting the design of the mail.

The method according to the invention provides for an automated ordering and performing of printing services and mailing services in a mailing service system, with which the order data for mail to be printed and sent is generated by a mobile terminal. The method is characterized by several steps, starting with the generation of order data by means of a mobile terminal, whereby the order data includes at least one image motif and of delivery information. The motif can be purely an image or else image-text combinations.

The mobile terminal preferably belongs to a mobile system. The order data is transmitted within this mobile system from the mobile terminal to a preparation component of the mobile system which, in turn, transfers the data to a verification and processing component. The order data is checked in the verification and processing component, processed and then transmitted to an interface of the mailing service system. Prior to that, the order data is stored in a database. In particular, erroneous data, or else data with which an error occurred when it was transmitted to the interface, is stored in the database accordingly. From the interface, the data is transmitted to a second database, whereby this database belongs to the mailing service system. The database is connected to an editing component that edits the order data to produce a printing order. Then the printing order is transmitted to a printing production component and the mail is produced in this printing production component. The mail thus generated is transferred to a distribution system, and the printing service and/or the mailing service is invoiced by means of an invoicing component of the mailing service system.

Therefore, with the method, it is possible to carry out an automated printing service in the form of printing mail and an automated mailing service in the form of transporting and delivering the mail. In order to print the mail, the order data generated by a mobile terminal has to contain at least one image motif, whereas the delivery information provided by the user makes it possible to transport and deliver the mail to the intended recipient. In addition, a user can add a greeting text or else the image motif can be an image-text combination containing, for example, a greeting text.

In an especially preferred embodiment of the invention, the mail to be printed and sent is a postcard typically having an image motif side and a text side with a greeting text and delivery information. The mobile terminal employed is, for example, a mobile telephone. Here, it has proven to be advantageous to use terminals that support the Multimedia Messaging Standard (MMS). The transmission of MMS data makes it possible to send text, melodies, images and video sequences, whereby the message length, the design and the file size of an MMS message are advantageously unlimited. Therefore, a user can employ a mobile terminal to generate order data in the form of an MMS message including at least one image motif and of delivery information for mail such as a postcard. The image motif can be generated by the mobile terminal itself or else can be loaded onto it by another medium such as, for example, a digital camera. Thus, a user can send any desired image motif in the form of a postcard, which gives him a wide range of design options. A greeting text can also be entered freely, for example, via the keypad of a mobile telephone, whereby only the maximum length of the text is limited.

In an especially preferred embodiment of the invention, an invoicing component of the mailing service system invoices a second invoicing component for the costs incurred for the printing service and/or the mailing service, whereby the second invoicing component belongs to the mobile system. The costs incurred for a given service are settled by the invoicing component of the mobile system which, in turn, invoices a user of the mobile system. In an especially preferred embodiment of the invention, this is the user who generated the order for the mail on a mobile terminal. The invoicing can be carried out, for example, via the invoice for a mobile telephone that had been used.

In another embodiment of the invention, the invoicing is carried out via a third party, whereby this other user of the mobile system, for example, assumes the role of a sponsor and makes the service of sending postcards via mobile telephones available to other users completely free of charge or at a reduced rate.

The system according to the invention for the automated performing of printing services and mailing services, in which an order for mail to be printed and sent can be generated by a user on a mobile terminal, includes several components. The system generally includes at least one mobile system in conjunction with a mailing service system. However, other components can also be integrated. A mobile system is typically operated by a mobile telephone company in the form of a mobile wireless network with the associated components. Here, several different mobile wireless networks can be connected to the mailing service system. Each mobile system preferably includes several mobile terminals for generating order data, a preparation component for preparing the order data and means for transmitting the order data from the mobile terminal to this preparation component. The mobile system also includes a database for storing data and computing means for preparing data as well as an invoicing component. The computing means is typically at least one server.

Typically, a mobile system includes a plurality of mobile terminals that are connected via data transmission routes such as a GSM network or a UTMS network to one or more preparation components.

A mailing service system for ordering and performing printing services and mailing services can be operated, for example, by a postal service provider and can have various components for the automation of the processes. Such a system preferably includes at least one interface for accepting order data, a database for data and application management, an editing component for editing order data into printing orders, a printing production component for generating mail and an invoicing component for invoicing for the printing service and/or for the mailing service.

The entire system according to the invention includes—in addition to a mobile system—a verification and processing component for preparing order data and a database for storing order data as well as means for receiving and sending data. The verification and processing component carries out a verification and/or a processing of the order data according to prescribed specifications. Preferably, a filtering and a validation of the order data are carried out here.

It has proven to be especially advantageous for the verification and processing component to also carry out a conversion of the order data into data that can be read by the interface of the mailing service system. In an especially preferred embodiment of the invention, the interface of the mailing service system is an http interface. Since MMS data of a mobile terminal is typically transmitted via an mms-protocol or via an smtp-protocol, a conversion of the data and the further transfer via the http-protocol are carried out in the verification and processing component.

The verification and processing component can be located in the area of the mobile system or in the area of the mailing service system. However, it can also be configured as an independent component. The database connected to the verification and processing component can likewise belong to different systems.

In an especially preferred embodiment of the invention, the results of the filtering and validation of the order data are stored in a database. The data is thus available for additional process steps. These include, for example, the notification of users if an order for mail to be printed and sent could not be carried out. This also includes the information that, for a generated order that could not be carried out, no invoicing or only partial invoicing takes place via an invoicing component.

The method according to the invention and the associated system for carrying out the method entail various advantages. For one thing, it allows users of the system to order the sending of individual pieces of mail, whereby the users have a great deal of freedom in designing the mail themselves. A user can choose not only from among a given selection of image motifs, but he can also upload images that he has generated himself or images that have been generated by other media such as digital cameras. Aside from a limitation of the maximum length, the greeting text can also be entered freely by the user. Secondly, the user can generate an order on his mobile terminal virtually independently of his location. Moreover, he does not need any auxiliary means but rather can utilize existing functions without a need for modifications. The invoicing of costs incurred for the services the user has ordered is not associated with any extra effort since the invoicing is preferably done via his mobile telephone bill or through a deduction from his prepaid card. Consequently, the user does not have to sign up for a special billing system and enter personal data that he might not wish to provide just for a one-time sending of a piece of mail.

### BRIEF DESCRIPTION OF THE DRAWINGS

Additional advantages, special features and practical embodiments of the invention will be apparent from the following description of preferred embodiments of the invention, making reference to drawings.

The drawings show the following:

FIG. 1 a depiction of an especially preferred embodiment of the system according to the invention; and

FIG. 2 a depiction of the two printed sides of a postcard generated with the method and system according to the invention.

### DETAILED DESCRIPTION

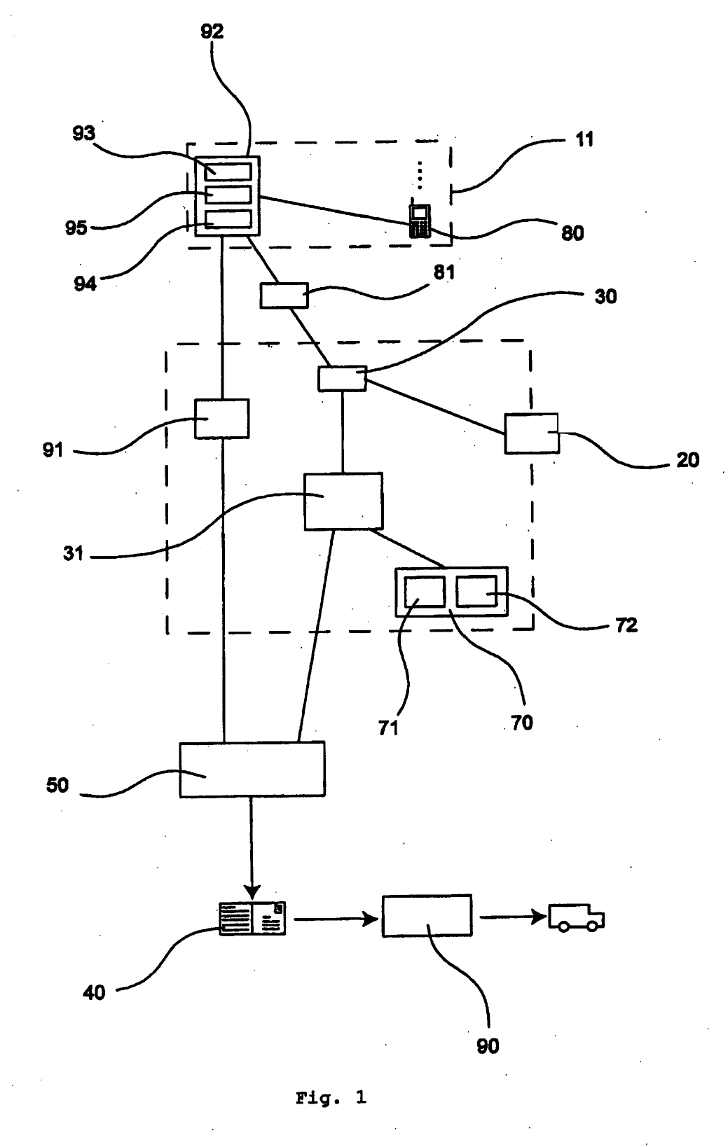

FIG. 1 shows an especially preferred embodiment of the system according to the invention for the automated ordering of printing services and mailing services via a mobile terminal 80. The system includes at least one mailing service system 10 and one mobile system 11. In the figure, the individual systems are delineated vis-à-vis other components by broken lines in order to illustrate which components are advantageous for the operation of the individual systems. However, various components can be omitted or additionally integrated.

The core element of the mailing service system 10 is made up of a database 31 that serves for data storage and data retrieval and that is connected to various components of the system. The entire data management is preferably implemented in a relational database. An Oracle database, for example, has proven to be advantageous as the database. The database is connected to an interface 30 via which data can be received from various order components. In addition to the generation of order data via a mobile terminal 80, orders can be generated, for example, via a website with an appertaining server. Such alternative means for generating order data are designated in the figure with the reference numeral 20. It is especially advantageous if the order data of various order components can be received by the mailing service system via the shared interface 30 with a uniform protocol. For example, an http-interface can be used for this purpose.

The database 31 is also connected to an editing component 70 for generating printing orders and to a printing production component 50 to which the generated printing orders are transmitted so that the mail can be produced. The system 10 also includes an invoicing component 91 that serves to invoice for the printing service and the mailing service provided by the system.

The editing component 70 of the mailing service system 10 preferably includes at least two components that are referred to here as back-end services 71 and 72. One of these components serves to generate the image motif whereas the other component generates preview data and printing data. The printing production component 50 can be a fixed component of the mailing service system or can be connected to the system modularly. This can be, for example, one or more printing service providers that print mail on behalf of the system. The printing production component generates mail 40 on the basis of the received data and then transfers the mail to a distribution system 90. The distribution system can include various sorting and distribution means for delivering mail to a recipient on the basis of the delivery information provided by the user. In an especially preferred embodiment of the invention, a connection exists between the printing production component 50 and an invoicing component 91, so that a message about printing and/or sending that has been carried out can be sent to this invoicing component.

The second essential component of the system according to the invention consists of a mobile system 11. Here, one or more mobile systems can be connected to the mailing service system 10. Each mobile system preferably includes at least one mobile terminal 80 for generating order data, a preparation component 92 for preparing the order data and a means for transmitting the order data from the mobile terminal to this preparation component. Typically, a mobile system includes a plurality of mobile terminals that are connected to one or more preparation components via data transmission routes such as a GSM network or a UTMS network.

The preparation component can be, for example, a Mobile Switching/Service Center (MSC) that, together with other components such as databases, typically performs the actual task of the telephone infrastructure. The compilation of invoicing data can be carried out, for example, in an invoicing component 93. A preparation component of the mobile system can also have a message center by means of which Short Message Service (SMS) messages, Multi Media Messages (MMS), voice messages of a voicemail box and e-mails can be processed.

With the method according to the invention, a mobile terminal 80 generates an order for a printing service in conjunction with a mailing service. This is preferably an order for sending a postcard. For this purpose, a user selects an image motif for printing the postcard and provides delivery information for sending the card. The selection of the image motif can be selected in different ways. For one thing, image motifs can be offered to the user among which he can choose. The image motif selection can be shown, for example, on a display of the mobile device. However, it is especially advantageous for the user to be able to choose a freely selectable image motif for the mail that is going to be sent. For example, for this purpose, he can generate an image with the mobile terminal, using the device as a camera. He can also upload an image generated by another medium.

The user enters the delivery information needed for an order, for example, via the keypad of the mobile device. The delivery information includes at least the name of the recipient and his address with the street, postal code and city. In addition, the user can enter a greeting text. The length of this text is limited. Advantageously, the maximum length of the text is shown to the user.

The order data thus generated is transmitted to a preparation component 92 of the mobile system. The transmission is carried out via a mobile telephone network. The format of the transmitted data is preferably the MMS format. Within the preparation component, the MMS data is stored on computing means 94 such as servers or transmitting computers. These transmitting computers are preferably computers with fixed IP addresses. A numeric address of a network subscriber under TCP/IP is designated as an IP address. TCP/IP are the two protocols that ensure the data exchange in networks upon which Internet services such as WWW, FTP, eMail, News, etc. are based. TCP is the abbreviation for Transmission Control Protocol. IP is the abbreviation for Internet Protocol.

The transmitting computers 94 transmit the received MMS data to the verification and processing component 81. Since the verification and processing component can belong to a mobile system 11, to a mailing service system 10 or to a system of its own, it is shown in FIG. 1 between the systems.

The verification and processing component 81 receives the MMS data from the transmitting computers. The transmission is preferably carried out via a coordinated protocol such as the smtp-protocol. In a first step, the MMS data is filtered out. For example, only MMS data from computers with defined IP addresses or MMS data that also includes image information is accepted. If the MMS data does not contain any image data, it can either be declared to be erroneous or the missing image motif is replaced by a standard image motif. Moreover, the filters can be spam filters that filter out undesired and unsolicited advertising and mass-mailing orders. Furthermore, MMS data without images and MMS data that does not match defined size specifications can be filtered out. In an especially preferred embodiment of the invention, MMS texts that do not contain defined characters or character strings are likewise sorted out. For example, texts without postal codes or without separators can be sorted out.

In a second step, the text information of the MMS data undergoes a validation. The validation can include the checking and correction of the syntax and/or the semantics. The syntax can be adapted to the user input and results, for example, in: <name1>, <name2>, <street>, <postal code>, <city> and <text of maximum length>.

The syntax validation can also include an automatic syntax correction that is used in defined cases. For example, the separator “semicolon” is changed into the separator “comma” that, according to a syntax rule, can be obligatory. Moreover, the syntax validation checks the text length and shortens the text if it has exceeded the permissible number of characters.

Since erroneous inputs via mobile terminals are typical, another optimization in terms of the address has proven to be practical. Based on a logic that locates the postal code, the city and the street in the MMS message, in the case of syntactically or semantically incorrect MMS messages, an attempt is made to identity the city or the postal code and the street. These are subjected to an automatic address correction procedure on the basis of a street directory. For example, a street directory of Germany exists by means of which the detected delivery information of an MMS message can be corrected automatically in case of a positive match.

Syntactically correct texts are broken down into their logical constituents and then stored in a database. The database can likewise be located in the mobile system, in the mailing service system or in another area. Syntactically erroneous and not automatically correctable MMS data is likewise stored, after having been marked as being erroneous for purposes of a manual correction that might be carried out.

In another step, the image information of the MMS data is automatically edited. Depending on the initial format, the images are rotated, scaled or the dpi number is increased. Moreover, they are focused. The graphic routines needed for this purpose are provided, for example, via an application of the type offered by the Adobe company.

In a last step, the edited data is transmitted to the interface 30 of the mailing service system. If an error occurs during the transmission of the data and/or if an error is reported by the interface, then this data is likewise flagged in the database as being erroneous and, if these are protocol or transfer errors, this data is resent periodically.

Erroneous data is also identified by an automatic process in the database, whereby the sender is ascertained by an MSISDN number (Mobile Subscriber ISDN). The MSISDN is a subscriber number under which a subscriber can be reached. Thus, a message is sent to the sender informing him of the error that has occurred and providing general or specific instructions for the next submission of the customer. This notification is made, for example, in the form of an SMS or MMS.

The interface 30 transfers the order data to an editing component 70 of the mailing service system 10. In an especially preferred embodiment of the invention, the editing component 70 includes two so-called back-end services that preferably generate the PDF files needed for the subsequent printing production component 50. One back-end service 71 for producing image motifs generates printing data for the image motif. Another component 72 for producing text layouts generates a print-PDF of the text page. The print files are preferably generated as PDF files in a special postcard format that has, for example, crop marks and an additional edge so as to simplify the cutting of the postcard on the produced printing sheets.

The editing and conversion of data for the production of a postcard will be described below by way of an example. Here, it has proven to be advantageous that the text for a postcard to be produced can be submitted in three formats: plain text, RTF (Rich Text Format) and XML (Extensible Markup Language).

The XML format corresponds to the printing instructions as they are preferably processed on the part of the card production component. This allows one-lined text blocks, lines and images to be positioned with millimeter precision. That is why conversion to the XML format is preferable.

The plain text format is thus converted into an XML format in the editing component 70 so that a layout-production core only has to be able to process the XML format. The RTF format is likewise converted into XML by means of a module.

The plain text format corresponds to normal, unformatted text and is supplied by the mobile terminal 80 when the user enters the text into this terminal. As a rule, the typeface and size of the entire text of the card can be transferred by the front-end. It is preferred for the entered text to be positioned line-by-line by the back-end services of the editing component. If a text line is wider than the text area of a postcard, then a line break is inserted at a suitable space.

Preferably, the JPG format is supported for the image motif of a postcard. If the JPG image contains information about its resolution (in dpi), it is advantageous to use this information in order to determine the actual size of the image (in mm). If no information about the resolution is present, then advantageously a standard resolution is assumed. The standard resolution can be, for example, 72 dpi.

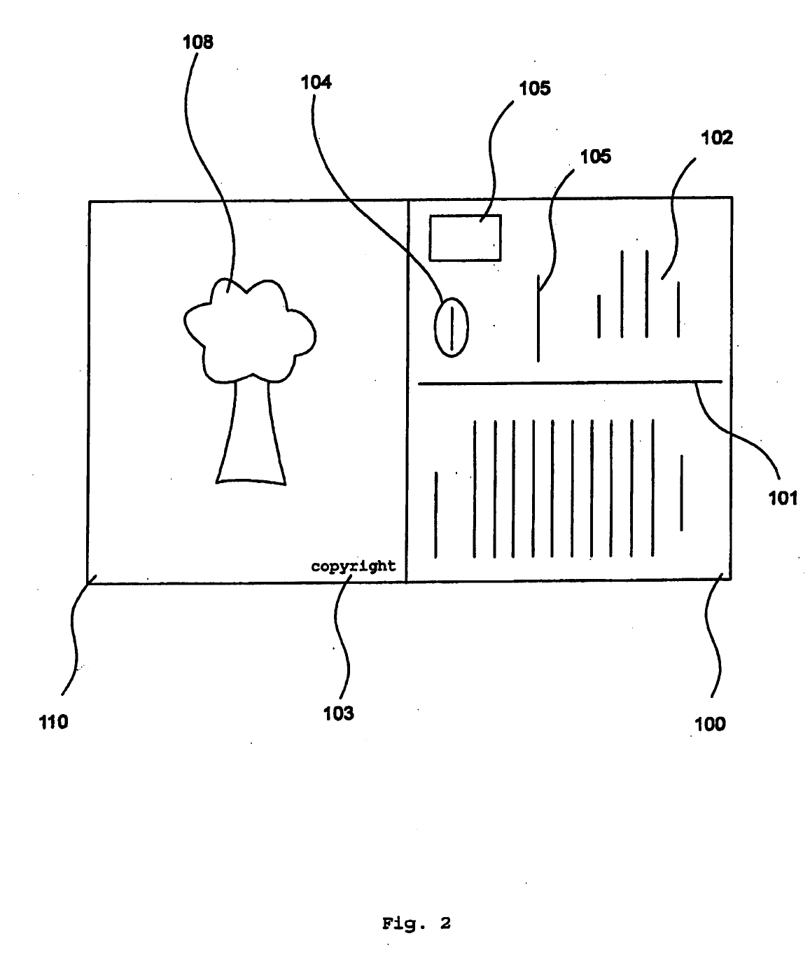

The documents to be printed include a production text page 100 and a production image motif page 110, as shown positioned next to each other in FIG. 2. The production text page 100 can contain, for example, elements such as the card text 101, delivery information (recipient address) 102, information on the copyright 103, a company logo 104, a postage indicium or a postage stamp 105, a prepaid postage marking 106 and/or a graphic element in the form of a vertical line 107 for dividing the postcard into two sections. Company logos or other customer-individual graphics, for example, can also be integrated into the image motif side of the postcard. The layout of this page can be predefined, whereby advantageously, certain parameters such as margins and distances can be configured.

Typefaces that are not standard typefaces in the PDF format and that are available in the TrueType format are embedded in the PDF file and can thus be made available to the printer.

If the user of the system uploads his own image motif, then a PDF file is generated containing the motif that was uploaded by the customer and that is positioned according to certain rules. If an image is not uploaded in a certain color model, it can be converted into the requisite color model. Since the CMYK color model is preferred for the printing of postcards, an image uploaded in an RGB color model is converted into the CMYK color model for the production PDF. For a preview image (JPG) to be generated, the RGB color model can be retained or else the image can be converted into the RGB color model if CMYK was uploaded.

The back-end services analyze the image uploaded by the user and generate a PDF file on this basis for the production. The scaling/positioning is not carried out by the back-end service but rather, it is integrated into the PDF file with the appropriate parameters (width, height, position). Hence, the image can be optimally computed by a RIP (Raster Image Processor). The image for the production is converted into the CMYK color model before its placement into the PDF file.

The editing component 70 transfers the printing orders generated by the back-end services to a printing production component 50 that carries out the printing orders. This printing production component is preferably configured in such a way that it can generate different postal products. Thus, for example, it can print postcards or letters. In order to be able to generate all kinds of postal products with the greatest flexibility possible, it can be advantageous here to connect various printing production components to the system 10 and/or to integrate them into the system. Thus, a given printing production component can, for instance, generate a specific postal product. When it comes to the printing production components, these can be the system's own components or else connected printing service providers that accept printing orders and, after executing them, transfer them to a distribution system 90.

In case the user has selected an image motif for a postcard from a predefined collection, these image motifs are present in a local memory of the printing production component 50 as preripped PostScript files with crop marks. The PostScript files have, for example, the format: 151.5 mm×108 mm. The crop marks are configured in such a way that the image is cropped to a format of 148.5 mm×105 mm. For production purposes, the printing production component 50 needs a storage reference to the local file in order to produce the printing instructions for the printer.

There are preripped PostScript files on the collator for all of the text pages. These files contain, for example, the postage indicium, the vertical line in the middle of the postcard and the prepaid postage marking. All other texts (copyright, text field, address field) are located in the PDF file that was generated by the back-end services. Moreover, for reprints, an unambiguous identification of the mailing is printed on the mailing within the printing data flow.

The invoicing for the printing and/or mailing service performed by the mailing service system 10 is carried out via an invoicing component 91 of the mailing service system. The invoicing component invoices a second invoicing component 92, which belongs to the mobile system 11, for the incurred costs. The second invoicing component settles this invoice and, in turn, charges the user of the mobile terminal who generated the order. The invoicing is preferably carried out via the mobile telephone bill of the user in question. Another possibility is invoicing through a deduction of monetary amounts from a prepaid card.

The costs for printed and sent mail can also be charged to another user, for example, if a sponsor participates in a mobile system in such a way as to offer other users a service for sending mail that is partially or completely free of charge.

### LIST OF REFERENCE NUMERALS

10 mailing service system
11 mobile system
20 order component
30 interface of mailing service system
31 database of mailing service system
40 mail product
50 printing production component
70 editing component, back-end services
71 image motif generation
72 text layout generation
80 mobile terminal
81 verification and processing component
90 distribution system
91 invoicing component of mailing service system
92 preparation component of mobile system
93 invoicing component of mobile system
94 computing means of mobile system, transmitting computer, server
95 database of mobile system
100 text page
101 card text
102 delivery information
103 information on copyrights
104 company logo
105 postage indicium, postage stamp
106 prepaid postage marking
107 graphic elements for postcard layout
108 postcard image motif
110 image motif side

1. A method for the automated ordering and performing of printing services and mailing services in a mailing service system, with which the order data for mail to be printed and sent is generated by a mobile terminal, whereby the mobile terminal belongs to a mobile system, the method comprising:
generating order data by a mobile ter-minal, whereby the order data comprises at least one image motif and of delivery information in the form of a mailing address;
transmitting the order data from the mobile terminal to a preparation component of the mobile system,
transmitting the order data from the preparation component of the mobile system to a verification and processing component,
checking and processing the order data in the verification and processing component and transmitting the order data to an interface of the mailing service system,
transmitting the order data from the interface to a database,
editing the order data into a printing order in an editing component that is connected to the database,
transmitting the printing order to a printing production component,
generating mail in the printing production component,
transferring the mail to a distribution system, and
invoicing for the printing service and/or mailing service via an invoicing component of the mailing service system,
wherein the invoicing component of the mailing service system invoices an invoicing component of the mobile system for printing service and/or mailing service.

2. The method according to claim 1,
wherein the order data generated by the mobile terminal is present in the form of MMS data (Multimedia Messaging Standard).

3. The method according to claim 1,
wherein the image motif for an order is an image generated on the user side or an image from a selection offered to him.

4. The method according to claim 1,
wherein the mail to be printed and sent is a postcard having an image motif side and a text side.

5. The method according to claim 1,
comprising transmitting the order data from one computer of the preparation component to the verification and processing component via a protocol that has been coordinated between the components.

6. The method according to claim 5,
wherein the coordinated protocol is the smtp protocol (Simple Mail Transfer Protocol).

7. The method according to claim 1,
comprising filtering the received order data according to predefined specifications.

8. The method according to claim 7,
wherein the filtering step comprises sorting out order data that was not sent by a computing means (94) of the mobile system (11) having a defined IP address.

9. The method according to claim 7,
wherein the filtering step comprises sorting out order data that does not contain any image data.

10. The method according to claim 7,
wherein the filtering step comprises sorting out order data containing unsolicited advertising and mass-mailing orders (spam data).

11. The method according to claim 7,
wherein the filtering step comprises sorting out order data for which the transmitted file size does not match a defined size range.

12. The method according to claim 7,
wherein the filtering step comprises sorting out order data that does not contain defined characters and/or character strings.

13. The method according to claim 1,
comprising the verification and processing component carrying out a validation of the received order data according to prescribed specifications.

14. The method according to claim 13,
wherein the validation step comprises checking the syntax and/or the semantics of the delivery information.

15. The method according to claim 13,
wherein the validation step comprises automatically correcting the syntax and/or the semantics of the delivery information.

16. The method according to claim 1,
comprising the verification and processing component carrying out a conversion of the order data into data that can be read by the interface of the mailing service system.

17. The method according to claim 16,
comprising the verification and processing component converting the order data from an smtp protocol transfer into an http protocol transfer.

18. The method according to claim 1,
comprising storing the order data processed by the verification and processing component in a database.

19. The method according to claim 18,
comprising storing the order data in the database, marking the order data as being erroneous, if said data is erroneous and/or cannot be corrected.

20. The method according to claim 18,
comprising storing the order data in the database, marking the order data as being erroneous, and
sending once again if an error occurred when the data was transmitted from the verification and processing component to the interface.

21. The method according to claim 1,
comprising automatically transmitting a message to the user who has generated order data on a mobile terminal if the checking and processing of the order data reveals that the ordered mail cannot be printed and/or mailed.

22. The method according to claim 21,
wherein a user of the mobile system is not invoiced or only partially invoiced for the ordered mail by the invoicing component of the mobile system if ordered mail cannot be printed and/or mailed.

23. A system for carrying out a method for automatically ordering and performing printing services and mailing services, with which an order for mail to be printed and sent can be generated on a mobile terminal by a user,
comprising means for the automated ordering and performing of printing services and mailing services using a method according to claim 1.

24. A system for the automated ordering and performing of printing services and mailing services, with which an order for mail to be printed and sent can be generated on a mobile terminal,
the system comprising:
a mobile system comprising at least one mobile terminal for generating order data, a preparation component for preparing the order data, an invoicing component for invoicing for services and a first transmitter for transmitting the order data from the mobile terminal to the preparation component;
a mailing service system comprising at least one interface for accepting order data, a database for data management and application management, an editing component for editing order data into printing orders, a printing production component for generating mail and an invoicing component for invoicing for the printing service and/or for the mailing service on the order component of the mobile system; and
a verification and processing component for preparing order data, a database for storing order data and a second transmitter for transmitting order data to the interface of the mailing service system.

25. The system according to claim 23,
wherein the verification and processing component belongs to the mobile system.

26. The system according to claim 23,
wherein the verification and processing component belongs to the mailing service system.

27. The system according to claim 23,
wherein the interface of the mailing service system is an http interface.
